(19) United States
(12) Patent Application Publication
(10) Pub. No.: US 2023/0339466 A1
(43) Pub. Date: Oct. 26, 2023

(54) CONTROL SYSTEM FOR AUTONOMOUS TRAVEL VEHICLE AND CONTROL METHOD FOR AUTONOMOUS TRAVEL VEHICLE

(71) Applicants: Komatsu Ltd., Tokyo (JP); Toyota Jidosha Kabushiki Kaisha, Toyota-shi (JP)

(72) Inventors: Takashi Hiranaka, Tokyo (JP); Shota Konishi, Tokyo (JP); Toru Takashima, Susono-shi (JP); Shun Mizoo, Zama-shi (JP); Shun Maruyama, Numazu-shi (JP); Takahiro Okano, Chiryu-shi (JP)

(73) Assignees: Komatsu Ltd., Tokyo (JP); Toyota Jidosha Kabushiki Kaisha, Toyota-shi (JP)

(21) Appl. No.: 18/301,384

(22) Filed: Apr. 17, 2023

(30) Foreign Application Priority Data
Apr. 22, 2022 (JP) 2022-070692

(51) Int. Cl. B60W 30/16; B60W 60/00; E02F 9/20

(52) U.S. Cl. CPC B60W 30/16; B60W 60/001; E02F 9/205; E02F 9/2045; B60W 2554/4041; E02F 3/435

(57) ABSTRACT

A control system for an autonomous travel vehicle includes: a work machine position acquisition unit that acquires a position of a work machine; an autonomous travel vehicle position acquisition unit that acquires a position of the autonomous travel vehicle; a human information acquisition unit that acquires human information indicating whether or not a person is present inside the autonomous travel vehicle; and a command generation unit that changes control of the autonomous travel vehicle based on the human information and a positional relationship between the work machine and the autonomous travel vehicle.

### CROSS-REFERENCE TO RELATED APPLICATION(S)

The present application claims priority to and incorporates by reference the entire contents of Japanese Patent Application No. 2022-070692 filed in Japan on Apr. 22, 2022.

### BACKGROUND OF THE INVENTION

### 1. Field of the Invention

The present disclosure relates to a control system for an autonomous travel vehicle and a control method for an autonomous travel vehicle.

### 2. Description of the Related Art

In a technical field related to a control system for an autonomous travel vehicle, a traffic control system as disclosed in JP 2017-10110 A is known.

In a case where a person is transported by an autonomous travel vehicle at a work site, it is necessary to suppress a decrease in productivity at the work site while ensuring safety of a passenger of the autonomous travel vehicle.

An object of the present disclosure is to suppress a decrease in productivity at a work site while ensuring safety of a passenger of an autonomous travel vehicle.

### SUMMARY OF THE INVENTION

It is an object of the present invention to at least partially solve the problems in the conventional technology.

According to an aspect of the present invention, a control system for an autonomous travel vehicle, the system comprises: a work machine position acquisition unit that acquires a position of a work machine; an autonomous travel vehicle position acquisition unit that acquires a position of the autonomous travel vehicle; a human information acquisition unit that acquires human information indicating whether or not a person is present inside the autonomous travel vehicle; and a command generation unit configured to change control of the autonomous travel vehicle based on the human information and a positional relationship between the work machine and the autonomous travel vehicle.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a work site according to a first embodiment;

FIG. 2 is a schematic diagram illustrating a management system of the work site according to the first embodiment;

FIG. 3 is a block diagram illustrating the management system of the work site according to the first embodiment;

FIG. 4 is a hardware configuration diagram of a management device according to the first embodiment;

FIG. 5 is a schematic diagram for explaining travel data and a permissible area of an unmanned light vehicle according to the first embodiment;

FIG. 6 is a schematic diagram for explaining travel data and a permissible area of an unmanned dump truck according to the first embodiment;

FIG. 7 is a diagram illustrating a state in which the unmanned light vehicle is traveling on a travel road in a state in which no person is present inside the unmanned light vehicle according to the first embodiment;

FIG. 8 is a diagram illustrating a state in which the unmanned light vehicle is traveling on a travel road in a state in which a person is present inside the unmanned light vehicle according to the first embodiment;

FIG. 9 is a flowchart illustrating a method of controlling the unmanned light vehicle according to the first embodiment;

FIG. 10 is a diagram illustrating a state in which an unmanned light vehicle is traveling on a travel road in a state in which no person is present inside the unmanned light vehicle according to a second embodiment;

FIG. 11 is a diagram illustrating a state in which the unmanned light vehicle is traveling on a travel road in a state in which a person is present inside the unmanned light vehicle according to the second embodiment;

FIG. 12 is a flowchart illustrating a method of controlling an unmanned light vehicle according to the second embodiment;

FIG. 13 is a diagram illustrating a state in which an unmanned light vehicle is traveling in a loading yard in a state in which no person is present inside the unmanned light vehicle according to a third embodiment;

FIG. 14 is a diagram illustrating a state in which the unmanned light vehicle is traveling in the loading yard in a state in which a person is present inside the unmanned light vehicle according to the third embodiment;

FIG. 15 is a flowchart illustrating a method of controlling the unmanned light vehicle according to the third embodiment;

FIG. 16 is a diagram illustrating a state in which an unmanned light vehicle is traveling on a travel road in a state in which no person is present inside the unmanned light vehicle according to a fourth embodiment; and

FIG. 17 is a diagram illustrating a state in which the unmanned light vehicle is traveling on a travel road in a state in which a person is present inside the unmanned light vehicle according to the fourth embodiment.

### DETAILED DESCRIPTION OF THE PREFERRED EMBODIMENTS

Hereinafter, embodiments according to the present disclosure will be described with reference to the drawings, but the present disclosure is not limited to the embodiments. The components of the embodiments described below can be appropriately combined. Furthermore, some components may not be used.

### First Embodiment

A first embodiment will be described.

### Work Site

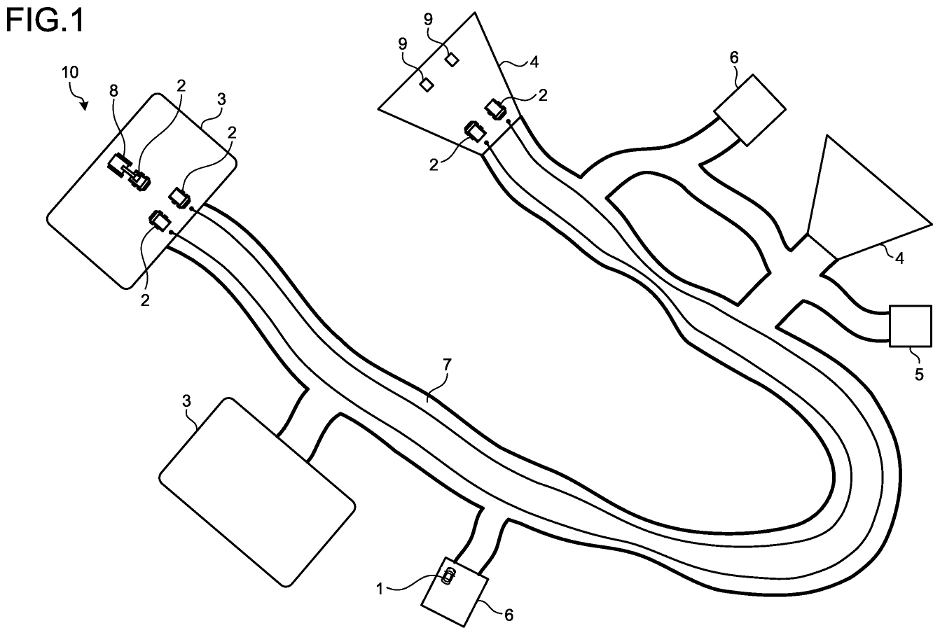

FIG. 1 is a schematic diagram illustrating a work site 10 according to the present embodiment. As the work site 10, a wide-area work site such as a mine or a quarry is exemplified. The mine refers to a place or a place of business where minerals are mined. A quarry refers to a place or business site where stones are mined. Examples of the mine include a metal mine for mining metal, a non-metal mine for mining limestone, and a coal mine for mining coal.

In the work site 10, an autonomous travel vehicle 1, a work machine 2, and a work machine 8 operate. The autonomous travel vehicle refers to a vehicle that travels without a driver's driving operation.

In the present embodiment, the autonomous travel vehicle 1 is a lightweight vehicle that travels through the work site 10 without a driver. In the present embodiment, the autonomous travel vehicle 1 is appropriately referred to as an unmanned light vehicle 1.

In the present embodiment, the unmanned light vehicle 1 transports a person at the work site 10. That is, although a driver does not board the unmanned light vehicle 1, a passenger who does not perform the driving operation boards the unmanned light vehicle 1.

In the present embodiment, the work machine 2 is an unmanned vehicle that operates in an unmanned manner without depending on a driving operation by a driver. In a case where the work machine 2 travels at the work site 10, the driver does not board the work machine 2. Note that the driver may board the work machine 2 in maintenance of the work machine 2 and other predetermined work. In the present embodiment, the work machine 2 is a haul vehicle that performs a transport operation of transporting a load. The haul vehicle travels at the work site 10 in an unmanned manner. In the present embodiment, the work machine 2 is appropriately referred to as an unmanned dump truck 2.

In the present embodiment, the work machine 8 is a manned vehicle that operates by a driving operation by a driver. The driver boards the work machine 8. In the present embodiment, the work machine 8 is a loader that performs loading work of loading a cargo onto the unmanned dump truck 2. In the present embodiment, the work machine 8 is appropriately referred to as an excavator 8.

The work site 10 includes a loading yard 3, a soil discharging yard 4, a parking yard 5, a waiting yard 6, and a travel road 7.

The loading yard 3 is an area in which loading work for loading a cargo onto the unmanned dump truck 2 is performed. As the cargo, an excavated object excavated in the loading yard 3 is exemplified. The excavator 8 operates in the loading yard 3. The excavator 8 includes a travel device, a revolving body supported by the travel device, and working equipment supported by the revolving body. The excavator 8 can move at the work site 10 including the loading yard 3.

The soil discharging yard 4 is an area in which soil discharging work for discharging a cargo from the unmanned dump truck 2 is performed. A crusher 9 is provided in the soil discharging yard 4.

The parking yard 5 is an area where the unmanned dump truck 2 is parked.

The waiting yard 6 is an area where the unmanned light vehicle 1 waits.

The travel road 7 refers to an area where at least one of the unmanned light vehicle 1 and the unmanned dump truck 2 travels. The travel road 7 is provided so as to connect at least the loading yard 3 and the soil discharging yard 4. In the present embodiment, the travel road 7 is connected to each of the loading yard 3, the soil discharging yard 4, the parking yard 5, and the waiting yard 6.

The unmanned light vehicle 1 can travel in each of the loading yard 3, the soil discharging yard 4, the waiting yard 6, and the travel road 7. The unmanned dump truck 2 can travel in each of the loading yard 3, the soil discharging yard 4, the parking yard 5, and the travel road 7. For example, the unmanned dump truck 2 travels on the travel road 7 so as to reciprocate between the loading yard 3 and the soil discharging yard 4.

### Management System

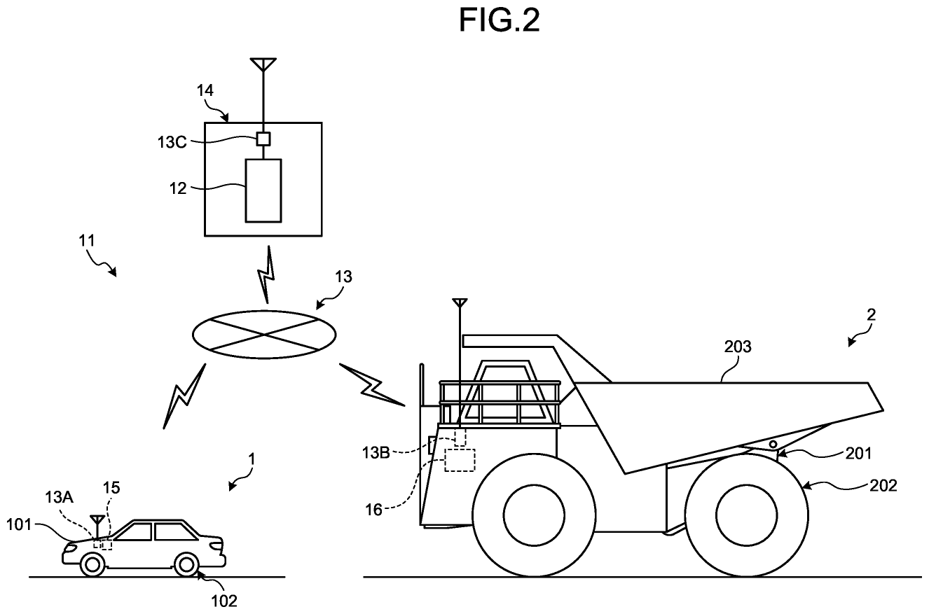

FIG. 2 is a schematic diagram illustrating a management system 11 of the work site 10 according to the present embodiment. The management system 11 includes a management device 12 and a communication system 13.

The management device 12 includes a computer system. The management device 12 is disposed outside the unmanned light vehicle 1, the unmanned dump truck 2, and the excavator 8. The management device 12 is installed in a control facility 14 of the work site 10. The management device 12 manages the work site 10. The management device 12 manages at least the unmanned light vehicle 1, the unmanned dump truck 2, and the excavator 8.

Examples of the communication system 13 include the Internet, a mobile phone communication network, a satellite communication network, and a local area network (LAN).

The unmanned light vehicle 1 includes a vehicle body 101, a travel device 102, a control device 15, and a wireless communication device 13A. The control device 15 includes a computer system. The wireless communication device 13A is connected to the control device 15.

The unmanned dump truck 2 includes a vehicle body 201, a travel device 202, a dump body 203, a control device 16, and a wireless communication device 13B. The control device 16 includes a computer system. The wireless communication device 13B is connected to the control device 16.

The communication system 13 includes the wireless communication device 13A connected to the control device 15, the wireless communication device 13B connected to the control device 16, and a wireless communication device 13C connected to the management device 12. The management device 12 and the control device 15 of the unmanned light vehicle 1 perform wireless communication via the communication system 13. The management device 12 and the control device 16 of the unmanned dump truck 2 perform wireless communication via the communication system 13.

The vehicle body 101 includes a vehicle body frame. The vehicle body 101 is supported by the travel device 102. The travel device 102 travels while supporting the vehicle body 101. The travel device 102 includes a wheel, a tire mounted on the wheel, an engine, a brake device, and a steering device.

The vehicle body 201 includes a vehicle body frame. The vehicle body 201 is supported by the travel device 202. The travel device 202 travels while supporting the vehicle body 201. The travel device 202 includes a wheel, a tire mounted on the wheel, an engine, a brake device, and a steering device. The dump body 203 is a member on which a load is loaded. The dump body 203 is supported by the vehicle body 201. The dump body 203 performs a dumping operation and a lowering operation. The dump operation refers to an operation of separating the dump body 203 from the vehicle body 201 and inclining the dump body in a dump direction. The lowering operation refers to an operation of bringing the dump body 203 close to the vehicle body 201. In a case where loading work is performed, the dump body 203 performs the lowering operation. In a case where soil discharging work is performed, the dump body 203 performs the dumping operation.

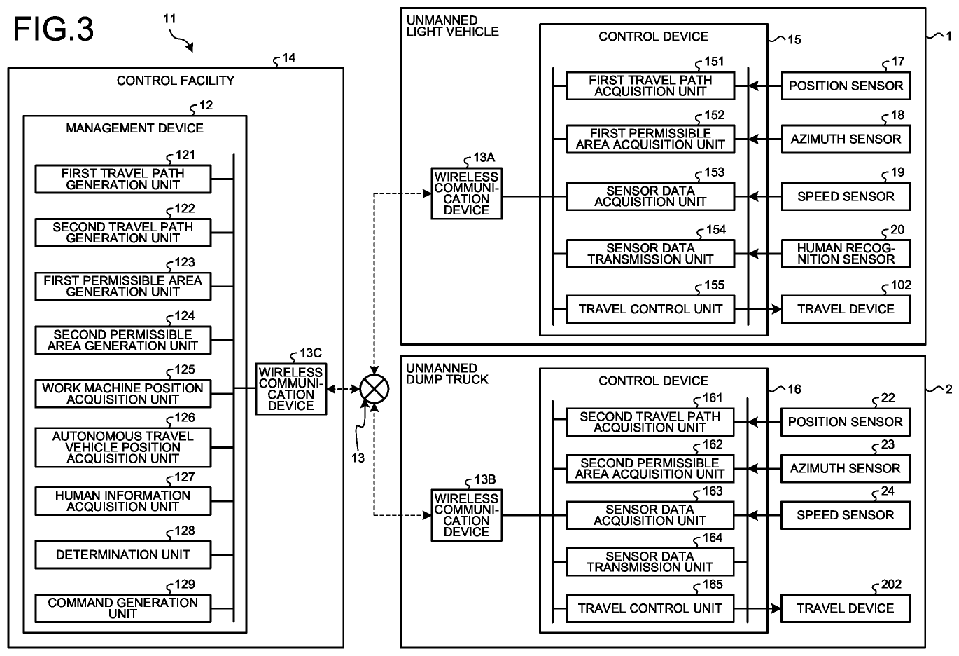

FIG. 3 is a block diagram illustrating the management system 11 of the work site 10 according to the present embodiment.

The unmanned light vehicle 1 includes the control device 15, the wireless communication device 13A, a position sensor 17, an azimuth sensor 18, a speed sensor 19, a human recognition sensor 20, and the travel device 102. Each of the wireless communication device 13A, the position sensor 17, the azimuth sensor 18, the speed sensor 19, and the human recognition sensor 20 can communicate with the control device 15. The travel device 102 is controlled by the control device 15.

The position sensor 17 detects a position of the unmanned light vehicle 1. The position of the unmanned light vehicle 1 is detected using a global navigation satellite system (GNSS). The global navigation satellite system includes a global positioning system (GPS). The global navigation satellite system detects a position in a global coordinate system defined by coordinate data of latitude, longitude, and altitude. The global coordinate system refers to a coordinate system fixed to the earth. The position sensor 17 includes a GNSS receiver and detects an absolute position of the unmanned light vehicle 1 indicating a position of the unmanned light vehicle 1 in the global coordinate system.

The azimuth sensor 18 detects an azimuth of the unmanned light vehicle 1. The azimuth of the unmanned light vehicle 1 includes a yaw angle of the unmanned light vehicle 1. In a case where an axis extending in a vertical direction at a center of gravity of the vehicle body 101 is a yaw axis, the yaw angle refers to a rotation angle around the yaw axis. A gyro sensor is exemplified as the azimuth sensor 18.

The speed sensor 19 detects a travel speed of the unmanned light vehicle 1. As the speed sensor 19, a pulse sensor that detects rotation of a wheel of the unmanned light vehicle 1 is exemplified.

The human recognition sensor 20 recognizes whether or not a person is present inside the unmanned light vehicle 1. That is, the human recognition sensor 20 detects the presence or absence of a passenger in the unmanned light vehicle 1. A seat on which a passenger sits is disposed inside the unmanned light vehicle 1. As the human recognition sensor 20, a pressure-sensitive sensor provided on the sheet is exemplified. Note that the human recognition sensor 20 may be a weight sensor that detects a weight of the passenger or an in-vehicle camera that acquires an image of the passenger.

The unmanned dump truck 2 includes the control device 16, the wireless communication device 13B, a position sensor 22, an azimuth sensor 23, a speed sensor 24, and the travel device 202. Each of the wireless communication device 13B, the position sensor 22, the azimuth sensor 23, and the speed sensor 24 can communicate with the control device 16. The travel device 202 is controlled by the control device 16.

The position sensor 22 detects a position of the unmanned dump truck 2. The position sensor 22 includes a GNSS receiver and detects an absolute position of the unmanned dump truck 2 indicating a position of the unmanned dump truck 2 in the global coordinate system.

The azimuth sensor 23 detects an azimuth of the unmanned dump truck 2. A gyro sensor is exemplified as the azimuth sensor 23.

The speed sensor 24 detects a travel speed of the unmanned dump truck 2. As the speed sensor 24, a pulse sensor that detects rotation of a wheel of the unmanned dump truck 2 is exemplified.

The management device 12 includes a first travel path generation unit 121, a second travel path generation unit 122, a first permissible area generation unit 123, a second permissible area generation unit 124, a work machine position acquisition unit 125, an autonomous travel vehicle position acquisition unit 126, a human information acquisition unit 127, a determination unit 128, and a command generation unit 129.

The first travel path generation unit 121 generates travel data indicating a travel condition of the unmanned light vehicle 1. The first travel path generation unit 121 transmits the travel data to the unmanned light vehicle 1 via the communication system 13.

The second travel path generation unit 122 generates travel data indicating a travel condition of the unmanned dump truck 2. The second travel path generation unit 122 transmits the travel data to the unmanned dump truck 2 via the communication system 13.

The first permissible area generation unit 123 generates a permissible area 33 for permitting the unmanned light vehicle 1 to travel. The first permissible area generation unit 123 transmits the permissible area 33 to the unmanned light vehicle 1 via the communication system 13.

The second permissible area generation unit 124 generates a permissible area 43 for permitting the unmanned dump truck 2 to travel. The second permissible area generation unit 124 transmits the permissible area 43 to the unmanned dump truck 2 via the communication system 13.

The work machine position acquisition unit 125 acquires a position of the unmanned dump truck 2. As described above, the unmanned dump truck 2 includes the position sensor 22 that detects the position of the unmanned dump truck 2. The work machine position acquisition unit 125 acquires the position of the unmanned dump truck 2 by acquiring detection data of the position sensor 22 via the communication system 13.

Furthermore, the work machine position acquisition unit 125 acquires a position of the excavator 8. The excavator 8 is provided with a position sensor that detects a position of the excavator 8. The position sensor of the excavator 8 includes a GNSS receiver, and detects an absolute position of the excavator 8 indicating a position of the excavator 8 in the global coordinate system. The work machine position acquisition unit 125 acquires the position of the excavator 8 by acquiring detection data of the position sensor of the excavator 8 via the communication system 13.

The autonomous travel vehicle position acquisition unit 126 acquires a position of the unmanned light vehicle 1. As described above, the unmanned light vehicle 1 has the position sensor 17 that detects the position of the unmanned light vehicle 1. The autonomous travel vehicle position acquisition unit 126 acquires the position of the unmanned light vehicle 1 by acquiring detection data of the position sensor 17 via the communication system 13.

The human information acquisition unit 127 acquires human information indicating whether or not a person is present inside the unmanned light vehicle 1. As described above, the unmanned light vehicle 1 includes the human recognition sensor 20 that recognizes whether or not a person is present inside the unmanned light vehicle 1. The human information acquisition unit 127 acquires the human information indicating whether or not a person is present inside the unmanned light vehicle 1 by acquiring detection data of the human recognition sensor 20 via the communication system 13.

The determination unit 128 determines whether or not a person is present inside the unmanned light vehicle 1 on the basis of the human information acquired by the human information acquisition unit 127. Furthermore, the determination unit 128 can recognize a positional relationship (relative position) between the unmanned dump truck 2 and the unmanned light vehicle 1 on the basis of the position of the unmanned dump truck 2 acquired by the work machine position acquisition unit 125 and the position of the unmanned light vehicle 1 acquired by the autonomous travel vehicle position acquisition unit 126. The determination unit 128 determines whether or not to change the control of the unmanned light vehicle 1 based on the human information and the positional relationship between the unmanned dump truck 2 and the unmanned light vehicle 1.

Furthermore, the determination unit 128 can recognize a positional relationship (relative position) between the excavator 8 and the unmanned light vehicle 1 based on the position of the excavator 8 acquired by the work machine position acquisition unit 125 and the position of the unmanned light vehicle 1 acquired by the autonomous travel vehicle position acquisition unit 126. The determination unit 128 determines whether or not to change the control of the unmanned light vehicle 1 based on the human information and the positional relationship between the excavator 8 and the unmanned light vehicle 1.

The command generation unit 129 changes the control of the unmanned light vehicle 1 on the basis of the human information and the positional relationship between the unmanned dump truck 2 and the unmanned light vehicle 1. Furthermore, the command generation unit 129 changes the control of the unmanned light vehicle 1 based on the human information and the positional relationship between the excavator 8 and the unmanned light vehicle 1. That is, in a case where the determination unit 128 determines to change the control of the unmanned light vehicle 1, the command generation unit 129 changes the control of the unmanned light vehicle 1.

In the present embodiment, changing the control of the unmanned light vehicle 1 includes changing a travel condition of the unmanned light vehicle 1. Changing the travel condition of the unmanned light vehicle 1 includes changing the travel data and the permissible area 33 of the unmanned light vehicle 1.

The travel condition of the unmanned light vehicle 1 includes a travel speed of the unmanned light vehicle 1. Furthermore, the travel condition of the unmanned light vehicle 1 includes one or both of the maximum value of the acceleration of the unmanned light vehicle 1 and the maximum value of the deceleration of the unmanned light vehicle 1.

The command generation unit 129 changes the travel speed of the unmanned light vehicle 1 based on the human information. In a case where no person is present inside the unmanned light vehicle 1, the command generation unit 129 causes the unmanned light vehicle 1 to travel at a first travel speed V1. In a case where a person is present inside the unmanned light vehicle 1, the command generation unit 129 causes the unmanned light vehicle 1 to travel at a second travel speed V2 lower than the first travel speed V1.

The command generation unit 129 may change the travel speed of the unmanned light vehicle 1 on the basis of the human information and the positional relationship between the unmanned dump truck 2 or the excavator 8 and the unmanned light vehicle 1. For example, even if a person is present inside the unmanned light vehicle 1, in a case where the unmanned dump truck 2 and the excavator 8 are not present around the unmanned light vehicle 1, the command generation unit 129 may cause the unmanned light vehicle 1 to travel at the first travel speed V1. In a case where a person is present inside the unmanned light vehicle 1 and at least one of the unmanned dump truck 2 and the excavator 8 is present around the unmanned light vehicle 1, the command generation unit 129 may cause the unmanned light vehicle 1 to travel at the second travel speed V2.

The command generation unit 129 changes one or both of the maximum value of the acceleration and the maximum value of the deceleration of the unmanned light vehicle 1 based on the human information. In a case where no person is present inside the unmanned light vehicle 1, the command generation unit 129 sets the maximum value of the acceleration of the unmanned light vehicle 1 to a first acceleration or sets the maximum value of the deceleration to a first deceleration. In a case where a person is present inside the unmanned light vehicle 1, the command generation unit 129 sets the maximum value of the acceleration of the unmanned light vehicle 1 to a second acceleration lower than the first acceleration, or sets the maximum value of the deceleration to a second deceleration lower than the first deceleration.

The command generation unit 129 may change one or both of the maximum value of the acceleration and the maximum value of the deceleration of the unmanned light vehicle 1 on the basis of the human information and the positional relationship between the unmanned dump truck 2 or the excavator 8 and the unmanned light vehicle 1. For example, even if a person is present inside the unmanned light vehicle 1, in a case where the unmanned dump truck 2 and the excavator 8 are not present around the unmanned light vehicle 1, the command generation unit 129 may set the maximum value of the acceleration of the unmanned light vehicle 1 to the first acceleration or set the maximum value of the deceleration to the first deceleration. In a case where a person is present inside the unmanned light vehicle 1 and at least one of the unmanned dump truck 2 and the excavator 8 is present around the unmanned light vehicle 1, the command generation unit 129 may set the maximum value of the acceleration of the unmanned light vehicle 1 to the second acceleration or the maximum value of the deceleration to the second deceleration.

In the present embodiment, the command generation unit 129 outputs a change command to the first travel path generation unit 121 so that the travel data of the unmanned light vehicle 1 is changed on the basis of the human information and the positional relationship between the unmanned dump truck 2 and the unmanned light vehicle 1. Furthermore, the command generation unit 129 outputs a change command to the first permissible area generation unit 123 so that the permissible area 33 of the unmanned light vehicle 1 is changed on the basis of the human information and the positional relationship between the unmanned dump truck 2 and the unmanned light vehicle 1. The travel data and the permissible area 33 indicating the changed travel condition are transmitted from the management device 12 to the unmanned light vehicle 1. The first travel path generation unit 121 transmits the changed travel data to the unmanned light vehicle 1. The first permissible area generation unit 123 transmits the changed permissible area 33 to the unmanned light vehicle 1.

The control device 15 includes a first travel path acquisition unit 151, a first permissible area acquisition unit 152, a sensor data acquisition unit 153, a sensor data transmission unit 154, and a travel control unit 155.

The first travel path acquisition unit 151 acquires the travel data of the unmanned light vehicle 1 generated by the first travel path generation unit 121 from the management device 12 via the communication system 13.

The first permissible area acquisition unit 152 acquires the permissible area 33 of the unmanned light vehicle 1 generated by the first permissible area generation unit 123 from the management device 12 via the communication system 13.

The sensor data acquisition unit 153 acquires detection data of the position sensor 17, detection data of the azimuth sensor 18, and detection data of the speed sensor 19.

The sensor data transmission unit 154 transmits the detection data of the position sensor 17 and detection data of the human recognition sensor 20 to the management device 12 through the communication system 13.

The travel control unit 155 controls the travel device 102 based on the travel data of the unmanned light vehicle 1 acquired by the first travel path acquisition unit 151, the permissible area 33 of the unmanned light vehicle 1 acquired by the first permissible area acquisition unit 152, and the detection data acquired by the sensor data acquisition unit 153.

The control device 16 includes a second travel path acquisition unit 161, a second permissible area acquisition unit 162, a sensor data acquisition unit 163, a sensor data transmission unit 164, and a travel control unit 165.

The second travel path acquisition unit 161 acquires the travel data of the unmanned dump truck 2 generated by the second travel path generation unit 122 from the management device 12 via the communication system 13.

The second permissible area acquisition unit 162 acquires the permissible area 43 of the unmanned dump truck 2 generated by the second permissible area generation unit 124 from the management device 12 via the communication system 13.

The sensor data acquisition unit 163 acquires detection data of the position sensor 22, detection data of the azimuth sensor 23, and detection data of the speed sensor 24.

The sensor data transmission unit 164 transmits the detection data of the position sensor 22 to the management device 12 via the communication system 13.

The travel control unit 165 controls the travel device 202 on the basis of the travel data of the unmanned dump truck 2 acquired by the second travel path acquisition unit 161, the permissible area 43 of the unmanned dump truck 2 acquired by the second permissible area acquisition unit 162, and the detection data acquired by the sensor data acquisition unit 163.

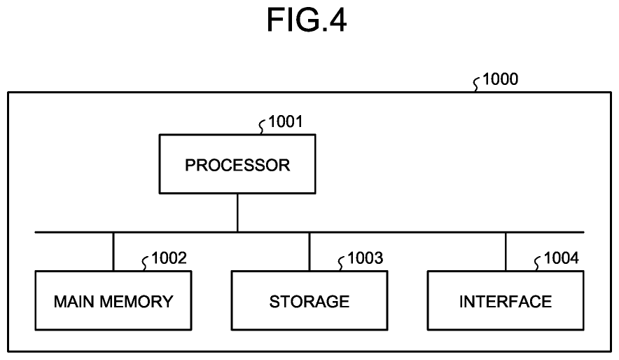

FIG. 4 is a hardware configuration diagram of the management device 12 according to the present embodiment. The management device 12 includes a computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. The functions of the management device 12 described above are stored in the storage 1003 as a computer program. The processor 1001 reads the computer program from the storage 1003, develops the computer program in the main memory 1002, and executes the above-described processing according to the program. Note that the computer program may be distributed to the computer system 1000 via a network.

Each of the control device 15 and the control device 16 includes a computer system 1000 as illustrated in FIG. 4. The functions of the control device 15 and the control device 16 described above are stored in the storage 1003 as a computer program.

### Travel Data and Permissible Area

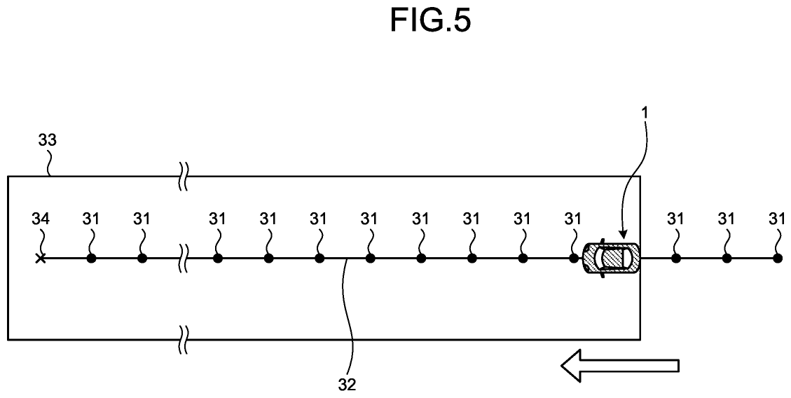

FIG. 5 is a schematic diagram for explaining the travel data and the permissible area 33 of the unmanned light vehicle 1 according to the present embodiment.

The travel data of the unmanned light vehicle 1 defines travel conditions of the unmanned light vehicle 1. The travel data of the unmanned light vehicle 1 includes a travel point 31, a travel path 32, a target position of the unmanned light vehicle 1, a target azimuth of the unmanned light vehicle 1, and a target travel speed of the unmanned light vehicle 1. The travel data of the unmanned light vehicle 1 including the travel path 32 is generated by the first travel path generation unit 121.

A plurality of the travel points 31 are set at the work site 10. Each of the travel points 31 defines a target position of the unmanned light vehicle 1. The target azimuth of the unmanned light vehicle 1 and the target travel speed of the unmanned light vehicle 1 are set at each of the plurality of travel points 31. The plurality of travel points 31 are set at intervals. The intervals between the travel points 31 may be uniform or non-uniform.

The travel path 32 refers to a virtual line indicating a target travel route of the unmanned light vehicle 1. The travel path 32 is defined by a trajectory passing through the plurality of travel points 31. The unmanned light vehicle 1 travels through the work site 10 according to the travel path 32. The unmanned light vehicle 1 travels such that a center of the unmanned light vehicle 1 coincides with the travel path 32 in a vehicle width direction of the unmanned light vehicle 1.

The target position of the unmanned light vehicle 1 refers to a target position of the unmanned light vehicle 1 when passing through each of the travel points 31. The target position of the unmanned light vehicle 1 may be defined in the local coordinate system of the unmanned light vehicle 1 or may be defined in the global coordinate system.

The target azimuth of the unmanned light vehicle 1 refers to a target azimuth of the unmanned light vehicle 1 when passing through the travel point 31.

The target travel speed of the unmanned light vehicle 1 refers to a target travel speed of the unmanned light vehicle 1 when passing through the travel point 31.

The first permissible area generation unit 123 generates the permissible area 33 for permitting the unmanned light vehicle 1 to travel and a stop point 34 of the unmanned light vehicle 1. The permissible area 33 functions as an entry prohibited area that prohibits entry of surrounding vehicles traveling around the unmanned light vehicle 1. In the present embodiment, the surrounding vehicles around the unmanned light vehicle 1 include another unmanned light vehicle 1 and the unmanned dump truck 2. The permissible area 33 is set in a traveling direction of the unmanned light vehicle 1. In a case where the unmanned light vehicle 1 moves forward, at least a part of the permissible area 33 is set in front of the unmanned light vehicle 1. The permissible area 33 is set in a band shape so as to include the travel path 32. Furthermore, the permissible area 33 is set to include the unmanned light vehicle 1. In the vehicle width direction of the unmanned light vehicle 1, a width of the permissible area 33 is larger than a vehicle width of the unmanned light vehicle 1. The stop point 34 is set at a tip of the permissible area 33. The travel speed of the unmanned light vehicle 1 is controlled so that the unmanned light vehicle 1 can stop at the stop point 34.

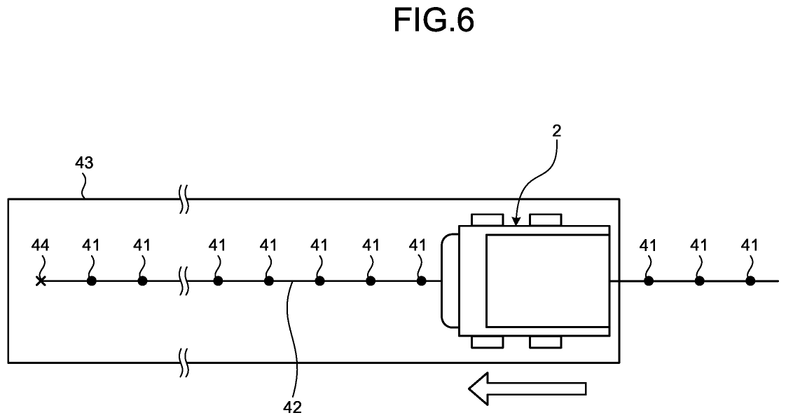

FIG. 6 is a schematic diagram for explaining the travel data and the permissible area 43 of the unmanned dump truck 2 according to the present embodiment.

The travel data of the unmanned dump truck 2 defines a travel condition of the unmanned dump truck 2. The travel data of the unmanned dump truck 2 includes a travel point 41, a travel path 42, a target position of the unmanned dump truck 2, a target azimuth of the unmanned dump truck 2, and a target travel speed of the unmanned dump truck 2. The travel data of the unmanned dump truck 2 including the travel path 42 is generated by the second travel path generation unit 122. The unmanned dump truck 2 travels such that a center of the unmanned dump truck 2 coincides with the travel path 42 in the vehicle width direction of the unmanned dump truck 2. Since the function of the travel point 41 and the function of the travel path 42 of the unmanned dump truck 2 are similar to the function of the travel point 31 and the function of the travel path 32 of the unmanned light vehicle 1, the description thereof will be omitted.

The second permissible area generation unit 124 generates the permissible area 43 in which the unmanned dump truck 2 is permitted to travel, and a stop point 44 of the unmanned dump truck 2. The permissible area 43 is set to include the unmanned dump truck 2. In the vehicle width direction of the unmanned dump truck 2, a width of the permissible area 43 is larger than a vehicle width of the unmanned dump truck 2. Since the function of the permissible area 43 and the function of the stop point 44 of the unmanned dump truck 2 are similar to the function of the permissible area 33 and the function of the stop point 34 of the unmanned light vehicle 1, the description thereof will be omitted.

The first permissible area generation unit 123 generates the permissible area 33 for each of a plurality of the unmanned light vehicles 1. The first permissible area generation unit 123 generates the permissible area 33 so that a plurality of the permissible areas 33 do not overlap each other. The first permissible area generation unit 123 generates the permissible area 33 so as not to overlap with the permissible area 43 of the unmanned dump truck 2.

The second permissible area generation unit 124 generates the permissible area 43 for each of a plurality of the unmanned dump trucks 2. The second permissible area generation unit 124 generates the permissible area 43 so that a plurality of the permissible areas 43 do not overlap each other. The second permissible area generation unit 124 generates the permissible area 43 so as not to overlap with the permissible area 33 of the unmanned light vehicle 1.

The first permissible area generation unit 123 sequentially updates the permissible area 33 as the unmanned light vehicle 1 travels. The first permissible area generation unit 123 sequentially releases the permissible area 33 through which the unmanned light vehicle 1 has passed. The first permissible area generation unit 123 sequentially extends the permissible area 33 before the unmanned light vehicle 1 passes in the traveling direction of the unmanned light vehicle 1. When the permissible area 33 after the unmanned light vehicle 1 passes is released, the other unmanned light vehicle 1 and the unmanned dump truck 2 can travel. As the permissible area 33 before the unmanned light vehicle 1 passes is extended, the traveling of the unmanned light vehicle 1 is continued. In a case where an event that the permissible area 33 cannot be extended occurs, the unmanned light vehicle 1 stops at the stop point 34. As an event in which the permissible area 33 cannot be extended, an event in which another unmanned light vehicle 1 or the unmanned dump truck 2 is stopped in front of the permissible area 33 is exemplified.

The second permissible area generation unit 124 sequentially updates the permissible area 43 as the unmanned dump truck 2 travels. The second permissible area generation unit 124 sequentially releases the permissible area 43 through which the unmanned dump truck 2 has passed. The second permissible area generation unit 124 sequentially extends the permissible area 43 before the unmanned dump truck 2 passes in the traveling direction of the unmanned dump truck 2. When the permissible area 43 after the unmanned dump truck 2 passes is released, another unmanned dump truck 2 and the unmanned light vehicle 1 can travel. As the permissible area 43 before the unmanned dump truck 2 passes is extended, the traveling of the unmanned dump truck 2 is continued. In a case where an event that the permissible area 43 cannot be extended occurs, the unmanned dump truck 2 stops at the stop point 44. As an event in which the permissible area 43 cannot be extended, an event in which another unmanned dump truck 2 or the unmanned light vehicle 1 is stopped in front of the permissible area 43 is exemplified.

The travel control unit 155 controls the travel device 102 so that the unmanned light vehicle 1 travels along the travel path 32 based on the travel data of the unmanned light vehicle 1, the permissible area 33 of the unmanned light vehicle 1, and the detection data acquired by the sensor data acquisition unit 153.

The travel control unit 155 controls the travel device 102 so as to reduce a deviation between a detection position of the unmanned light vehicle 1 detected by the position sensor 17 when passing through the travel point 31 and the target position of the unmanned light vehicle 1 set at the travel point 31.

The travel control unit 155 controls the travel device 102 so as to reduce a deviation between a detected azimuth of the unmanned light vehicle 1 detected by the azimuth sensor 18 when passing through the travel point 31 and the target azimuth of the unmanned light vehicle 1 set at the travel point 31.

The travel control unit 155 controls the travel device 102 so as to reduce a deviation between a detected travel speed of the unmanned light vehicle 1 detected by the speed sensor 19 when passing through the travel point 31 and the target travel speed of the unmanned light vehicle 1 set at the travel point 31.

The travel control unit 155 controls the travel device 102 on the basis of the permissible area 33 and the permissible area 43. In a case where an event that the permissible area 33 cannot be extended occurs, the travel control unit 155 controls the travel device 102 so that the unmanned light vehicle 1 stops at the stop point 34. The travel control unit 155 controls the travel device 102 so that the unmanned light vehicle 1 does not enter the permissible area 33 set for another unmanned light vehicle 1 and the permissible area 43 set for the unmanned dump truck 2.

The travel control unit 165 controls the travel device 202 such that the unmanned dump truck 2 travels along the travel path 42 on the basis of the travel data of the unmanned dump truck 2, the permissible area 43 of the unmanned dump truck 2, and the detection data acquired by the sensor data acquisition unit 163.

The travel control unit 165 controls the travel device 202 so as to reduce a deviation between a detection position of the unmanned dump truck 2 detected by the position sensor 22 when passing through the travel point 41 and a target position of the unmanned dump truck 2 set at the travel point 41.

The travel control unit 165 controls the travel device 202 so as to reduce a deviation between a detected azimuth of the unmanned dump truck 2 detected by the azimuth sensor 23 when passing through the travel point 41 and a target azimuth of the unmanned dump truck 2 set at the travel point 41.

The travel control unit 165 controls the travel device 202 so as to reduce a deviation between a detected travel speed of the unmanned dump truck 2 detected by the speed sensor 24 when passing through the travel point 41 and a target travel speed of the unmanned dump truck 2 set at the travel point 41.

The travel control unit 165 controls the travel device 202 on the basis of the permissible area 43 and the permissible area 33. In a case where an event that the permissible area 43 cannot be extended occurs, the travel control unit 165 controls the travel device 202 so that the unmanned dump truck 2 stops at the stop point 44. The travel control unit 165 controls the travel device 202 so that the unmanned dump truck 2 does not enter the permissible area 43 set for another unmanned dump truck 2 and the permissible area 33 set for the unmanned light vehicle 1.

### Control Method

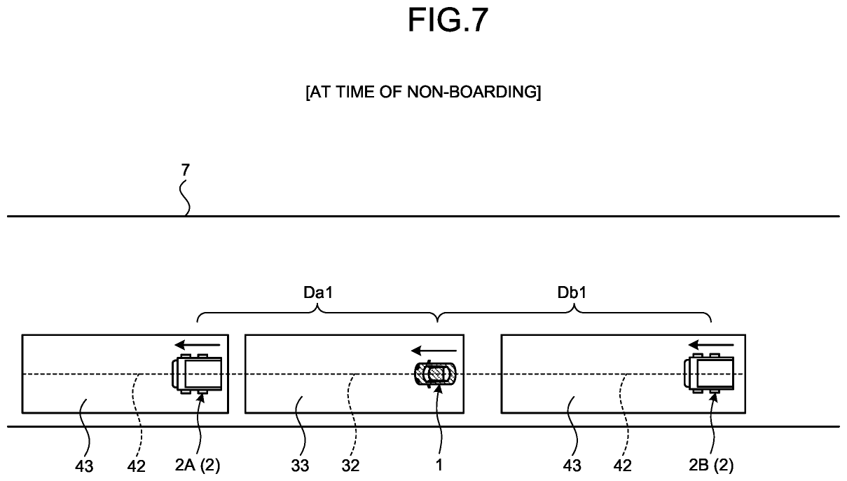

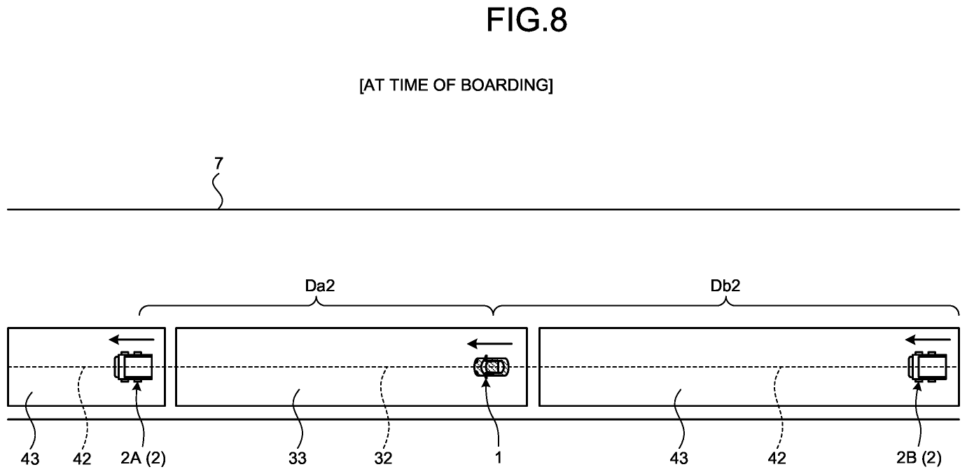

FIG. 7 is a diagram illustrating a state in which the unmanned light vehicle 1 is traveling on the travel road 7 in a state in which no person is present inside the unmanned light vehicle 1 according to the present embodiment. FIG. 8 is a diagram illustrating a state in which the unmanned light vehicle 1 is traveling on the travel road 7 in a state in which a person is present inside the unmanned light vehicle 1 according to the present embodiment.

In FIGS. 7 and 8, the unmanned dump truck 2 exists around the unmanned light vehicle 1. The unmanned dump truck 2 includes an unmanned dump truck 2A traveling in front of the unmanned light vehicle 1 and an unmanned dump truck 2B traveling behind the unmanned light vehicle 1. The unmanned dump truck 2A, the unmanned light vehicle 1, and the unmanned dump truck 2B travel in the same direction.

In the present embodiment, in a case where a person is present inside the unmanned light vehicle 1, the command generation unit 129 changes the control of one or both of the unmanned light vehicle 1 and the unmanned dump truck 2 such that a distance between the unmanned light vehicle 1 and the unmanned dump truck 2 existing around the unmanned light vehicle 1 becomes long. In a case where a person is present inside the unmanned light vehicle 1, the command generation unit 129 changes the control of one or both of the unmanned light vehicle 1 and the unmanned dump truck 2 such that the distance between the unmanned light vehicle 1 and the unmanned dump truck 2 existing around the unmanned light vehicle 1 becomes longer than in a case where no person is present inside the unmanned light vehicle 1.

In a case where an inter-vehicle distance between the unmanned light vehicle 1 and the unmanned dump truck 2A traveling in front of the unmanned light vehicle 1 is less than or equal to a predetermined threshold, the command generation unit 129 changes the control of the unmanned light vehicle 1 so that the inter-vehicle distance between the unmanned light vehicle 1 and the unmanned dump truck 2A becomes long.

In a case where an inter-vehicle distance between the unmanned light vehicle 1 and the unmanned dump truck 2B traveling behind the unmanned light vehicle 1 is less than or equal to a predetermined threshold, the command generation unit 129 changes the control of the unmanned dump truck 2B so that the inter-vehicle distance between the unmanned light vehicle 1 and the unmanned dump truck 2B becomes long.

In the present embodiment, changing the control of the unmanned light vehicle 1 includes changing the permissible area 33 of the unmanned light vehicle 1. Changing the control of the unmanned dump truck 2B includes changing the permissible area 43 of the unmanned dump truck 2B.

As illustrated in FIGS. 7 and 8, a length of the permissible area 33 of the unmanned light vehicle 1 at the time of boarding when a person is present inside the unmanned light vehicle 1 is longer than a length of the permissible area 33 of the unmanned light vehicle 1 at the time of non-boarding when no person is present inside the unmanned light vehicle 1. The length of the permissible area 33 refers to a dimension of the permissible area 33 in the traveling direction of the unmanned light vehicle 1.

As illustrated in FIGS. 7 and 8, a length of the permissible area 43 of the unmanned dump truck 2B at the time of boarding when a person is present inside the unmanned light vehicle 1 is longer than a length of the permissible area 43 of the unmanned dump truck 2B at the time of non-boarding when no person is present inside the unmanned light vehicle 1. The length of the permissible area 43 refers to a dimension of the permissible area 43 in the traveling direction of the unmanned dump truck 2B.

As illustrated in FIG. 7, the inter-vehicle distance between the unmanned light vehicle 1 and the unmanned dump truck 2A is set to a distance Da1, and the inter-vehicle distance between the unmanned light vehicle 1 and the unmanned dump truck 2B is set to a distance Db1. As illustrated in FIG. 8, at the time of boarding when a person is present inside the unmanned light vehicle 1, the inter-vehicle distance between the unmanned light vehicle 1 and the unmanned dump truck 2A is set to a distance Da2 longer than the distance Da1, and the inter-vehicle distance between the unmanned light vehicle 1 and the unmanned dump truck 2B is set to a distance Db2 longer than the distance Db1.

In the present embodiment, the inter-vehicle distance between the unmanned light vehicle 1 and the unmanned dump truck 2A is changed on the basis of the length of the permissible area 33 of the unmanned light vehicle 1. In the case of non-boarding, the length of the permissible area 33 is set to be short, and the inter-vehicle distance between the unmanned light vehicle 1 and the unmanned dump truck 2A is set to the distance Da1. In the case of boarding, the length of the permissible area 33 is set to be long, and the inter-vehicle distance between the unmanned light vehicle 1 and the unmanned dump truck 2A is set to the distance Da2.

In the present embodiment, the inter-vehicle distance between the unmanned light vehicle 1 and the unmanned dump truck 2B is changed on the basis of the length of the permissible area 43 of the unmanned dump truck 2B. In the case of non-boarding, the length of the permissible area 43 is set to be short, and the inter-vehicle distance between the unmanned light vehicle 1 and the unmanned dump truck 2B is set to the distance Db1. In the case of boarding, the length of the permissible area 43 is set to be long, and the inter-vehicle distance between the unmanned light vehicle 1 and the unmanned dump truck 2B is set to the distance Db2.

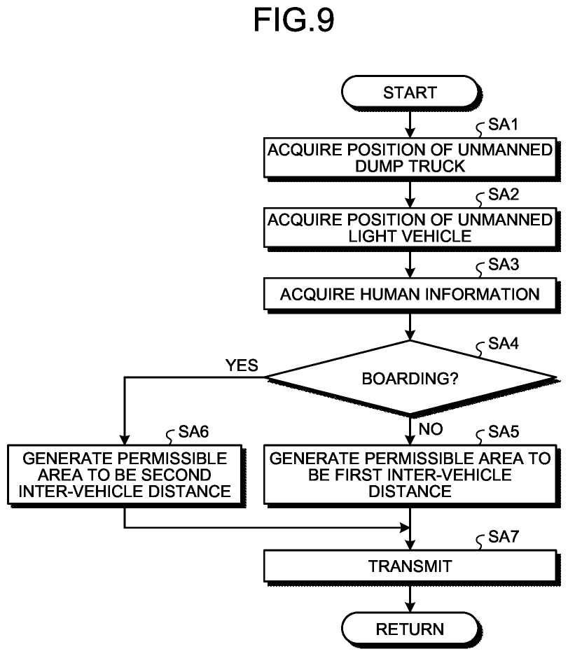

FIG. 9 is a flowchart illustrating a method of controlling the unmanned light vehicle 1 according to the present embodiment.

The work machine position acquisition unit 125 acquires the position of the unmanned dump truck 2 (Step SA1).

The autonomous travel vehicle position acquisition unit 126 acquires the position of the unmanned light vehicle 1 (Step SA2).

The human information acquisition unit 127 acquires human information (Step SA3).

The determination unit 128 determines whether or not a person is on the unmanned light vehicle 1 based on the human information acquired in Step SA3 (Step SA4).

In Step SA4, in a case where it is determined that the unmanned light vehicle 1 is in a non-boarding state where a person is not on board (Step SA4: No), the command generation unit 129 outputs a generation command to the first permissible area 123 so that the inter-vehicle distance between the unmanned light vehicle 1 and the unmanned dump truck 2A becomes the distance Da1 (first inter-vehicle distance). The first permissible area generation unit 123 generates the permissible area 33 so that the inter-vehicle distance between the unmanned light vehicle 1 and the unmanned dump truck 2A becomes the distance Da1. Furthermore, the command generation unit 129 outputs a generation command to the second permissible area generation unit 124 so that the inter-vehicle distance between the unmanned light vehicle 1 and the unmanned dump truck 2B becomes the distance Db1 (first inter-vehicle distance). The second permissible area generation unit 124 generates the permissible area 43 such that the inter-vehicle distance between the unmanned light vehicle 1 and the unmanned dump truck 2B becomes the distance Db1 (Step SA5).

In Step SA4, in a case where it is determined that the unmanned light vehicle 1 is in a boarding state where a person is boarding (Step SA4: Yes), the command generation unit 129 outputs a generation command to the first permissible area 123 so that the inter-vehicle distance between the unmanned light vehicle 1 and the unmanned dump truck 2A becomes the distance Da2 (second inter-vehicle distance). The first permissible area generation unit 123 generates the permissible area 33 so that the inter-vehicle distance between the unmanned light vehicle 1 and the unmanned dump truck 2A becomes the distance Da2. Furthermore, the command generation unit 129 outputs a generation command to the second permissible area generation unit 124 so that the inter-vehicle distance between the unmanned light vehicle 1 and the unmanned dump truck 2B becomes the distance Db2 (second inter-vehicle distance). The second permissible area generation unit 124 generates the permissible area 43 such that the inter-vehicle distance between the unmanned light vehicle 1 and the unmanned dump truck 2B becomes the distance Db2 (Step SA6).

The permissible area 33 generated in Step SA5 or Step SA6 is transmitted from the management device 12 to the unmanned light vehicle 1. Furthermore, the permissible area 43 generated in Step SA5 or Step SA6 is transmitted from the management device 12 to the unmanned dump truck 2B (Step SA7).

### Advantageous Effects

As described above, according to the present embodiment, the control of the unmanned light vehicle 1 is changed on the basis of the human information and the positional relationship between the unmanned dump truck 2 and the unmanned light vehicle 1. In the present embodiment, in a case where no person is present inside the unmanned light vehicle 1, the inter-vehicle distance between the unmanned light vehicle 1 and the unmanned dump truck 2A becomes short, and in a case where a person is present inside the unmanned light vehicle 1, the inter-vehicle distance between the unmanned light vehicle 1 and the unmanned dump truck 2A becomes long. At the time of non-boarding, the inter-vehicle distance becomes short, and thus, a decrease in productivity at the work site 10 is suppressed. At the time of boarding, since the inter-vehicle distance becomes long, the safety of a passenger of the unmanned light vehicle 1 is secured.

Furthermore, in a case where no person is present inside the unmanned light vehicle 1, the maximum value of the travel speed of the unmanned light vehicle 1 becomes high, and in a case where a person is present inside the unmanned light vehicle 1, the maximum value of the travel speed of the unmanned light vehicle 1 becomes low. At the time of non-boarding, since the unmanned light vehicle 1 travels at a high speed, a decrease in productivity at the work site 10 is suppressed. At the time of boarding, since the unmanned light vehicle 1 travels at a low speed, the safety of the passenger of the unmanned light vehicle 1 is secured.

Furthermore, in a case where no person is present inside the unmanned light vehicle 1, the maximum value of the acceleration of the unmanned light vehicle 1 becomes high, and in a case where a person is present inside the unmanned light vehicle 1, the maximum value of the acceleration of the unmanned light vehicle 1 becomes low. At the time of non-boarding, the unmanned light vehicle 1 accelerates at a high acceleration, so that a decrease in productivity at the work site 10 is suppressed. At the time of boarding, since the unmanned light vehicle 1 is suppressed from being rapidly accelerated, the safety of the passenger of the unmanned light vehicle 1 is secured. The same applies to the deceleration.

### Modification Example

In the present embodiment, the management device 12 includes the human information acquisition unit 127. The control device 15 of the unmanned light vehicle 1 may include the human information acquisition unit 127.

### Second Embodiment

A second embodiment will be described. In the following description, the same or equivalent components as those of the above-described embodiment are denoted by the same reference signs, and the description of the components is simplified or omitted.

### Control Method

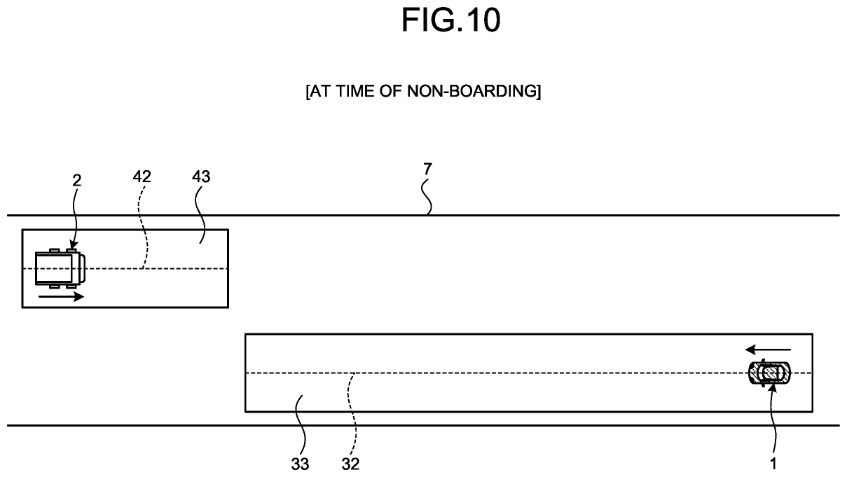

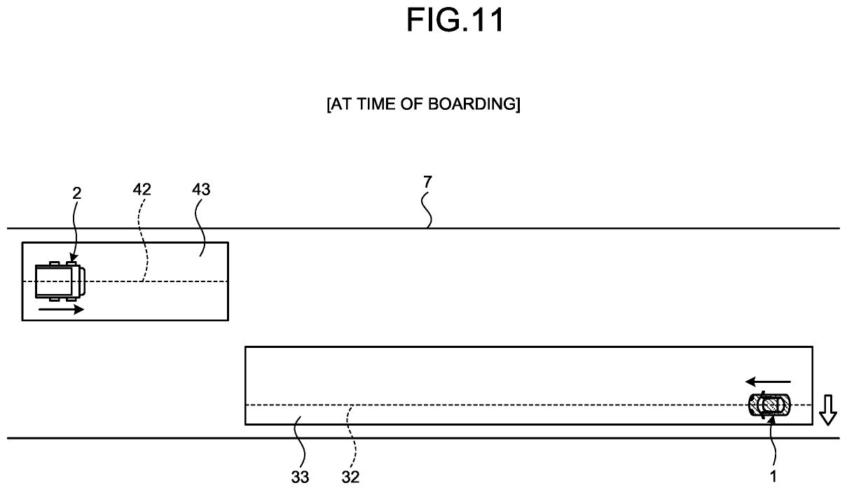

FIG. 10 is a diagram illustrating a state in which an unmanned light vehicle 1 is traveling on a travel road 7 in a state in which no person is present inside the unmanned light vehicle 1 according to the present embodiment. FIG. 11 is a diagram illustrating a state in which the unmanned light vehicle 1 is traveling on the travel road 7 in a state in which a person is present inside the unmanned light vehicle 1 according to the present embodiment.

As illustrated in FIGS. 10 and 11, in the present embodiment, a travel path 32 of the unmanned light vehicle 1 and a travel path 42 of an unmanned dump truck 2 are set so as to be aligned in the travel road 7 at a work site 10. The unmanned light vehicle 1 travels on the travel road 7 at the work site 10 according to the travel path 32 generated by a first travel path generation unit 121. The unmanned dump truck 2 travels on the travel road 7 at the work site 10 according to the travel path 42 generated by a second travel path generation unit 122.

In the example illustrated in FIGS. 10 and 11, the travel path 32 and the travel path 42 are substantially parallel. Furthermore, the travel path 32 and the travel path 42 are set such that the travel road 7 is an opposing two-lane travel road. The unmanned light vehicle 1 and the unmanned dump truck 2 pass in opposite directions. The unmanned dump truck 2 is an oncoming vehicle of the unmanned light vehicle 1. In the travel road 7, the unmanned light vehicle 1 and the unmanned dump truck 2 travel so as to pass each other. In the example illustrated in FIGS. 10 and 11, the unmanned light vehicle 1 travels in a first direction on a first travel lane on one side (left side) of the travel road 7 in a width direction of the travel road 7 based on the travel path 32. The unmanned dump truck 2 travels in a second travel lane on the other side (right side) of the travel road 7 in the width direction of the travel road 7 in a second direction opposite to the first direction based on the travel path 42.

The unmanned light vehicle 1 travels such that a center of the unmanned light vehicle 1 coincides with the travel path 32 in a vehicle width direction of the unmanned light vehicle 1. The unmanned dump truck 2 travels such that a center of the unmanned dump truck 2 coincides with the travel path 42 in the vehicle width direction of the unmanned dump truck 2. A permissible area 33 is set to include the travel path 32 and the unmanned light vehicle 1. A permissible area 43 is set to include the travel path 42 and the unmanned dump truck 2.

In the present embodiment, changing the control of the unmanned light vehicle 1 includes changing the travel path 32 of the unmanned light vehicle 1. Changing the control of the unmanned dump truck 2 includes changing the travel path 42 of the unmanned dump truck 2.

As illustrated in FIG. 10, in a case of non-boarding in which no person is present inside the unmanned light vehicle 1, a command generation unit 129 causes the first travel path generation unit 121 to generate the travel path 32 so that the unmanned light vehicle 1 travels on a central side of the first travel lane.

As illustrated in FIG. 11, at the time of boarding when a person is present inside the unmanned light vehicle 1, the command generation unit 129 shifts the travel path 32 of the unmanned light vehicle 1 to one side (left side) of the first travel lane so that a distance between the unmanned light vehicle 1 and the unmanned dump truck 2 becomes long when the unmanned light vehicle 1 and the unmanned dump truck 2 pass each other. That is, in the case of boarding, the command generation unit 129 separates the travel path 32 of the unmanned light vehicle 1 and the travel path 42 of the unmanned dump truck 2 such that the distance between the unmanned light vehicle 1 and the unmanned dump truck 2 becomes long when the unmanned light vehicle 1 and the unmanned dump truck 2 pass each other. In the present embodiment, the travel path 32 is changed so that the unmanned light vehicle 1 travels on a side of a road shoulder of the first travel lane.

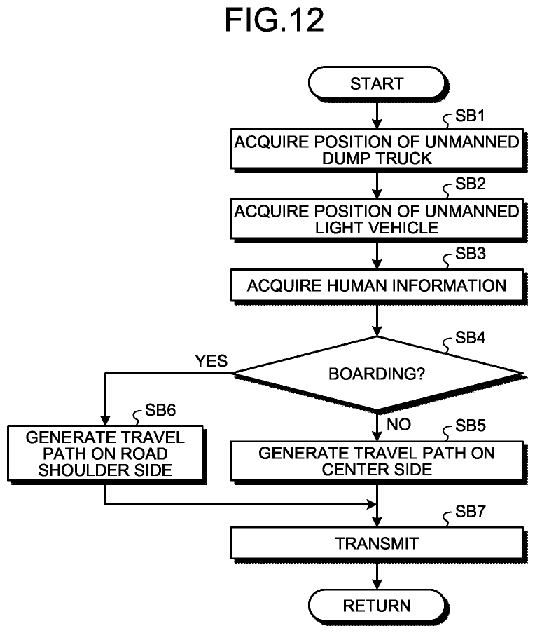

FIG. 12 is a flowchart illustrating a method of controlling the unmanned light vehicle 1 according to the present embodiment.

A work machine position acquisition unit 125 acquires the position of the unmanned dump truck 2 (Step SB1).

An autonomous travel vehicle position acquisition unit 126 acquires the position of the unmanned light vehicle 1 (Step SB2).

A human information acquisition unit 127 acquires human information (Step SB3).

A determination unit 128 determines whether or not a person is on the unmanned light vehicle 1 on the basis of the human information acquired in Step SB3 (Step SB4).

In Step SB4, in a case where it is determined that the unmanned light vehicle 1 is in a non-boarding state in which a person is not on board (Step SB4: No), the command generation unit 129 outputs a generation command to the first travel path generation unit 121 so that the unmanned light vehicle 1 travels on the center side of the first travel lane. The first travel path generation unit 121 generates the travel path 32 on the center side of the first travel lane (Step SB5).

In Step SB4, in a case where it is determined that the unmanned light vehicle 1 is in a boarding state in which a person is boarding (Step SB4: Yes), the command generation unit 129 outputs a generation command to the first travel path generation unit 121 so that the unmanned light vehicle 1 travels on the side of the road shoulder of the first travel lane. The first travel path generation unit 121 generates the travel path 32 on the side of the road shoulder of the first travel lane (Step SB6).

The travel path 32 generated in Step SB5 or Step SB6 is transmitted from a management device 12 to the unmanned light vehicle 1 (Step SB7).

### Advantageous Effects

As described above, also in the present embodiment, the control of the unmanned light vehicle 1 is changed on the basis of the human information and the positional relationship between the unmanned dump truck 2 and the unmanned light vehicle 1. In the present embodiment, in a case where no person is present inside the unmanned light vehicle 1, the travel path 32 of the unmanned light vehicle 1 when the unmanned light vehicle 1 and an unmanned dump truck 2A pass each other is generated on the center side of the first travel lane, and in a case where a person is present inside the unmanned light vehicle 1, the travel path 32 of the unmanned light vehicle 1 when the unmanned light vehicle 1 and the unmanned dump truck 2A pass each other is generated on the side of the road shoulder of the first travel lane. At the time of non-boarding, since the travel path 32 is generated on the center side of the first travel lane, a decrease in productivity at the work site 10 is suppressed. At the time of boarding, since the travel path 32 is generated on the side of the road shoulder of the first travel lane, the safety of the passenger of the unmanned light vehicle 1 is secured.

### Modification Example

In the present embodiment, the distance between the unmanned light vehicle 1 and the unmanned dump truck 2 when the unmanned light vehicle 1 and the unmanned dump truck 2 pass each other is increased by changing the travel path 32 of the unmanned light vehicle 1. The distance between the unmanned light vehicle 1 and the unmanned dump truck 2 when the unmanned light vehicle 1 and the unmanned dump truck 2 pass each other may be increased by changing the travel path 42 of the unmanned dump truck 2. In a case where a person is present inside the unmanned light vehicle 1, the command generation unit 129 may shift the travel path 42 of the unmanned dump truck 2 from a center side of the second travel lane to a side of a road shoulder so as to increase the distance between the unmanned light vehicle 1 and the unmanned dump truck 2 when the unmanned light vehicle 1 and the unmanned dump truck 2 pass each other.

### Third Embodiment

A third embodiment will be described. In the following description, the same or equivalent components as those of the above-described embodiment are denoted by the same reference signs, and the description of the components is simplified or omitted.

### Control Method

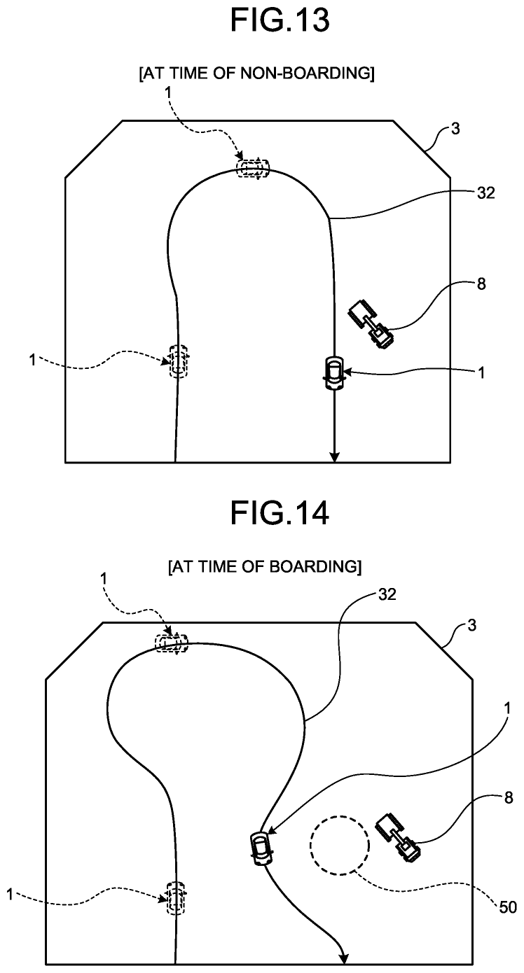

FIG. 13 is a diagram illustrating a state in which an unmanned light vehicle 1 is traveling in a loading yard 3 in a state in which no person is present inside the unmanned light vehicle 1 according to the present embodiment. FIG. 14 is a diagram illustrating a state in which the unmanned light vehicle 1 is traveling in the loading yard 3 in a state in which a person is present inside the unmanned light vehicle 1 according to the present embodiment.

In the present embodiment, in a case where a person is present inside the unmanned light vehicle 1, a command generation unit 129 makes a travel path 32 of the unmanned light vehicle 1 generated so as to be separated from an excavator 8 in the loading yard 3 where the excavator 8 operates. In the present embodiment, increasing a distance between the unmanned light vehicle 1 and the excavator 8 includes generating the travel path 32 so as to be separated from the excavator 8.

As illustrated in FIG. 13, in a case where no person is present inside the unmanned light vehicle 1, the command generation unit 129 makes the travel path 32 generated so that the unmanned light vehicle 1 passes through a target passing position set in the loading yard 3 and a travel distance in the loading yard 3 becomes the shortest distance.

As illustrated in FIG. 14, at the time of boarding when a person is present inside the unmanned light vehicle 1, the command generation unit 129 makes the travel path 32 generated so that the unmanned light vehicle 1 passes through the target passing position set in the loading yard 3 and detours the excavator 8. In the present embodiment, the travel path 32 is generated such that a space 50 is formed between the travel path and the excavator 8.

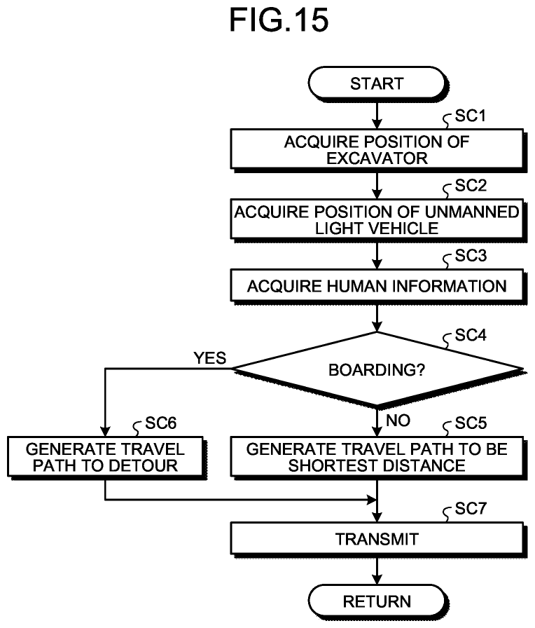

FIG. 15 is a flowchart illustrating a method of controlling the unmanned light vehicle 1 according to the present embodiment.

A work machine position acquisition unit 125 acquires the position of the excavator 8 (Step SC1).

An autonomous travel vehicle position acquisition unit 126 acquires the position of the unmanned light vehicle 1 (Step SC2).

A human information acquisition unit 127 acquires human information (Step SC3).

A determination unit 128 determines whether or not a person is on the unmanned light vehicle 1 on the basis of the human information acquired in Step SC3 (Step SC4).

In Step SC4, in a case where it is determined that the unmanned light vehicle 1 is in a non-boarding state in which a person is not on board (Step SC4: No), the command generation unit 129 outputs a generation command to a first travel path generation unit 121 so that a travel distance of the unmanned light vehicle 1 in the loading yard 3 becomes the shortest distance. The first travel path generation unit 121 generates the travel path 32 so that the unmanned light vehicle 1 passes through a target passing position set in the loading yard 3 and the travel distance in the loading yard 3 becomes the shortest distance (Step SC5).

In Step SC4, in a case where it is determined that the unmanned light vehicle 1 is in a boarding state in which a person is boarding (Step SC4: Yes), the command generation unit 129 outputs a generation command to the first travel path generation unit 121 so that the unmanned light vehicle 1 detours the excavator 8. The first travel path generation unit 121 generates the travel path 32 so that the unmanned light vehicle 1 passes through the target passing position set in the loading yard 3 and detours the excavator 8 (Step SC6).

The travel path 32 generated in Step SC5 or Step SC6 is transmitted from a management device 12 to the unmanned light vehicle 1 (Step SC7).

### Advantageous Effects

As described above, in the present embodiment, the control of the unmanned light vehicle 1 is changed on the basis of the human information and the positional relationship between the excavator 8 and the unmanned light vehicle 1. In the present embodiment, in a case where no person is present inside the unmanned light vehicle 1, the travel path 32 is generated such that the travel distance of the unmanned light vehicle 1 in the loading yard 3 becomes the shortest distance, and in a case where a person is present inside the unmanned light vehicle 1, the travel path 32 is generated such that the unmanned light vehicle 1 detours the excavator 8 in the loading yard 3. As a result, a decrease in productivity at a work site 10 is suppressed at the time of non-boarding, and the safety of the passenger of the unmanned light vehicle 1 is secured at the time of boarding.

### Fourth Embodiment

A fourth embodiment will be described. In the following description, the same or equivalent components as those of the above-described embodiment are denoted by the same reference signs, and the description of the components is simplified or omitted.

### Control Method

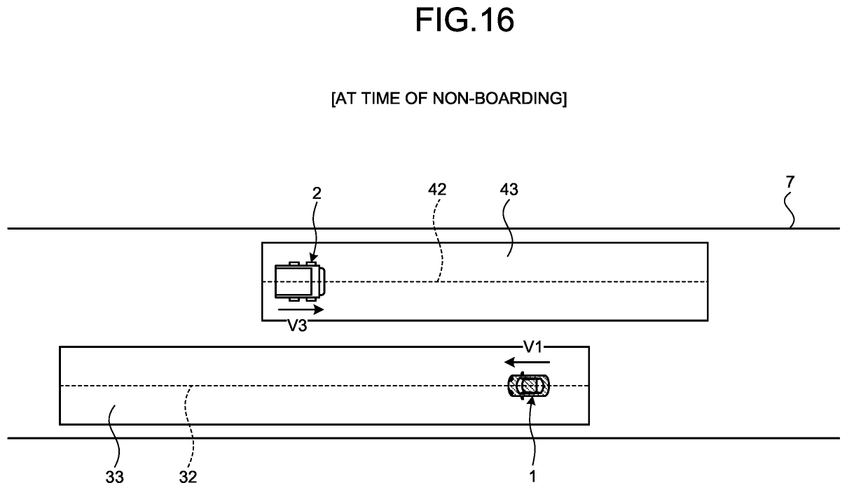

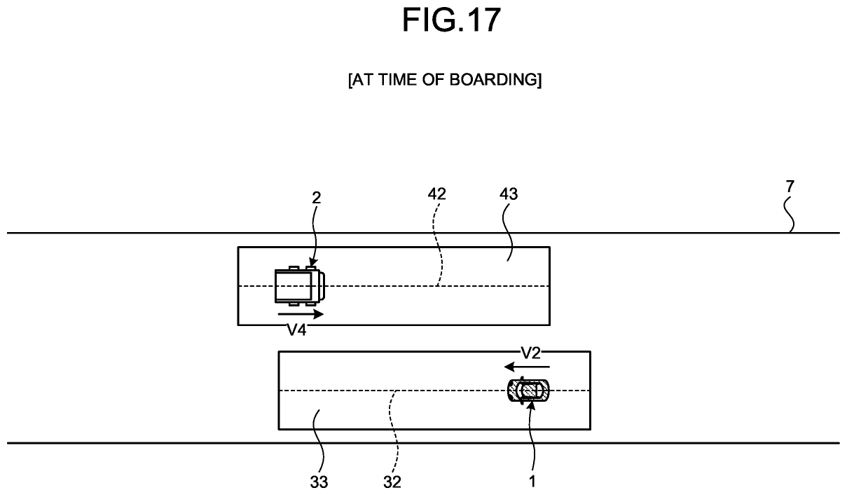

FIG. 16 is a diagram illustrating a state in which an unmanned light vehicle 1 is traveling on a travel road 7 in a state in which no person is present inside the unmanned light vehicle 1 according to the present embodiment. FIG. 17 is a diagram illustrating a state in which the unmanned light vehicle 1 is traveling on the travel road 7 in a state in which a person is present inside the unmanned light vehicle 1 according to the present embodiment.

As in the second embodiment described above, in the present embodiment, a travel path 32 of the unmanned light vehicle 1 and a travel path 42 of an unmanned dump truck 2 are set so as to be aligned in the travel road 7 of at a work site 10. The unmanned light vehicle 1 and the unmanned dump truck 2 travel so as to pass each other.

In the present embodiment, in a case where a person is present inside the unmanned light vehicle 1, a command generation unit 129 reduces a travel speed of the unmanned dump truck 2 present around the unmanned light vehicle 1. Furthermore, in the present embodiment, in a case where a person is present inside the unmanned light vehicle 1, the command generation unit 129 decreases the travel speed of the unmanned light vehicle 1.

As illustrated in FIG. 16, in a case of non-boarding in which no person is present inside the unmanned light vehicle 1, the command generation unit 129 causes the first travel path generation unit 121 to generate travel data of the unmanned light vehicle 1 so that the unmanned light vehicle 1 travels on a first travel lane at a first travel speed V1. Furthermore, in a case of non-boarding in which no person is present inside the unmanned light vehicle 1, the command generation unit 129 causes the second travel path generation unit 122 to generate travel data of the unmanned dump truck 2 so that the unmanned dump truck 2 travels on a second travel lane at a third travel speed V3.

As illustrated in FIG. 17, in a case of boarding in which a person is present inside the unmanned light vehicle 1, the command generation unit 129 causes the first travel path generation unit 121 to generate travel data of the unmanned light vehicle 1 so that the unmanned light vehicle 1 travels on the first travel lane at a second travel speed V2 lower than the first travel speed V1. Furthermore, in a case of boarding in which a person is present inside the unmanned light vehicle 1, the command generation unit 129 causes the second travel path generation unit 122 to generate travel data of the unmanned dump truck 2 so that the unmanned dump truck 2 travels on the second travel lane at a fourth travel speed V4 lower than the third travel speed V3.

### Advantageous Effects

As described above, also in the present embodiment, the control of the unmanned light vehicle 1 is changed on the basis of the human information and the positional relationship between the unmanned dump truck 2 and the unmanned light vehicle 1. In the present embodiment, in a case where no person is present inside the unmanned light vehicle 1, each of the unmanned light vehicle 1 and the unmanned dump truck 2 travels at a high speed, and in a case where a person is present inside the unmanned light vehicle 1, each of the unmanned light vehicle 1 and the unmanned dump truck 2 travels at a low speed. As a result, a decrease in productivity at a work site 10 is suppressed at the time of non-boarding, and the safety of the passenger of the unmanned light vehicle 1 is secured at the time of boarding.

### Modification Example

Note that, in the present embodiment, the travel speed of the unmanned light vehicle 1 may be the same between the time of non-boarding and the time of boarding. By the unmanned dump truck 2 traveling at a high speed at the time of non-boarding and the unmanned dump truck 2 traveling at a low speed at the time of boarding, a decrease in productivity at the work site 10 is suppressed at the time of non-boarding, and safety of a passenger of the unmanned light vehicle 1 is secured at the time of boarding. Note that the travel speed of the unmanned dump truck 2 may be the same at the time of non-boarding and at the time of boarding, the unmanned light vehicle 1 may travel at a high speed at the time of non-boarding, and the unmanned light vehicle 1 may travel at a low speed at the time of boarding.

According to the present disclosure, it is possible to suppress a decrease in productivity at a work site while ensuring safety of a passenger of an autonomous travel vehicle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A control system for an autonomous travel vehicle, the system comprising:
a work machine position acquisition unit that acquires a position of a work machine;
an autonomous travel vehicle position acquisition unit that acquires a position of the autonomous travel vehicle;
a human information acquisition unit that acquires human information indicating whether or not a person is present inside the autonomous travel vehicle; and
a command generation unit configured to change control of the autonomous travel vehicle based on the human information and a positional relationship between the work machine and the autonomous travel vehicle.

2. The control system for an autonomous travel vehicle according to claim 1, wherein
the work machine is a haul vehicle having a dump body.

3. The control system for an autonomous travel vehicle according to claim 1, further comprising
a human recognition sensor that recognizes whether or not a person is present inside the autonomous travel vehicle,
wherein the human information acquisition unit acquires the human information by acquiring detection data of the human recognition sensor.

4. The control system for an autonomous travel vehicle according to claim 1, further comprising
a management device that is disposed outside the autonomous travel vehicle and the work machine and manages the autonomous travel vehicle and the work machine,
wherein the management device includes the command generation unit,
to change the control of the autonomous travel vehicle includes to change a travel condition of the autonomous travel vehicle, and
travel data indicating the travel condition is transmitted from the management device to the autonomous travel vehicle.

5. The control system for an autonomous travel vehicle according to claim 4, wherein
the travel condition includes a travel speed of the autonomous travel vehicle.

6. The control system for an autonomous travel vehicle according to claim 4, wherein
the travel condition includes one or both of a maximum value of acceleration and a maximum value of deceleration of the autonomous travel vehicle.

7. The control system for an autonomous travel vehicle according to claim 1, wherein
the command generation unit in configured to change control of one or both of the autonomous travel vehicle and the work machine such that a distance between the autonomous travel vehicle and the work machine existing around the autonomous travel vehicle becomes long when a person is present inside the autonomous travel vehicle.

8. The control system for an autonomous travel vehicle according to claim 7, wherein
the command generation unit is configured to change control of the autonomous travel vehicle such that a distance between the autonomous travel vehicle and the work machine becomes long when the distance between the autonomous travel vehicle and the work machine is less than or equal to a threshold.

9. The control system for an autonomous travel vehicle according to claim 7, wherein
the command generation unit is configured to change control of the work machine such that a distance between the autonomous travel vehicle and the work machine becomes long when the distance between the autonomous travel vehicle and the work machine is less than or equal to a threshold.

10. The control system for an autonomous travel vehicle according to a claim 7, further comprising:
a first travel path generation unit that generates a travel path of the autonomous travel vehicle; and
a second travel path generation unit that generates a travel path of the work machine,
wherein the autonomous travel vehicle travels through a work site according to the travel path generated by the first travel path generation unit,
the work machine travels through the work site according to the travel path generated by the second travel path generation unit,
to change the control of the autonomous travel vehicle includes to change the travel path of the autonomous travel vehicle, and
to change the control of the work machine includes to change the travel path of the work machine.

11. The control system for an autonomous travel vehicle according to claim 10, wherein
the travel path of the autonomous travel vehicle and the travel path of the work machine are set so as to be aligned in a travel road at the work site,
the autonomous travel vehicle travels in a first direction on a first travel lane on one side in a width direction of the travel road based on the travel path generated by the first travel path generation unit,
the work machine travels in a second direction opposite to the first direction on a second travel lane on another side in the width direction of the travel road based on the travel path generated by the second travel path generation unit, and
the command generation unit shifts the travel path of the autonomous travel vehicle to the one side of the first travel lane such that a distance between the autonomous travel vehicle and the work machine becomes long when a person is present inside the autonomous travel vehicle.

12. The control system for an autonomous travel vehicle according to claim 7, further comprising
a first travel path generation unit that generates a travel path of the autonomous travel vehicle,
wherein the command generation unit makes the travel path generated so as to be separated from the work machine when a person is present inside the autonomous travel vehicle.

13. The control system for an autonomous travel vehicle according to claim 12, wherein
the work machine is an excavator including a revolving body and working equipment supported by the revolving body, and
the command generation unit makes a travel path generated so as to be separated from the work machine in a loading yard where the excavator operates.

14. The control system for an autonomous travel vehicle according to claim 1, wherein
the command generation unit reduces a travel speed of the work machine present around the autonomous travel vehicle when a person is present inside the autonomous travel vehicle.

15. A control method for an autonomous travel vehicle, the method comprising:
acquiring a position of a work machine;
acquiring a position of the autonomous travel vehicle;
acquiring human information indicating whether or not a person is present inside the autonomous travel vehicle; and
changing control of the autonomous travel vehicle based on the human information and a positional relationship between the work machine and the autonomous travel vehicle.

16. The control method for an autonomous travel vehicle according to claim 15, wherein
the changing the control of the autonomous travel vehicle includes changing a travel condition of the autonomous travel vehicle.

17. The control method for an autonomous travel vehicle according to claim 16, wherein
the travel condition includes a travel speed of the autonomous travel vehicle,
the autonomous travel vehicle travels at a first travel speed when no person is present inside the autonomous travel vehicle, and
the autonomous travel vehicle travels at a second travel speed lower than the first travel speed when a person is present inside the autonomous travel vehicle.

18. The method for controlling an autonomous vehicle according to claim 15, further comprising
changing control of one or both of the autonomous travel vehicle and the work machine such that a distance between the autonomous travel vehicle and the work machine existing around the autonomous travel vehicle becomes longer than when no person is present inside the autonomous travel vehicle, when a person is present inside the autonomous travel vehicle.

19. The control method for an autonomous travel vehicle according to claim 18, wherein
the autonomous travel vehicle travels through a work site according to a first travel path,
the work machine travels through the work site according to a second travel path, and
to make the distance between the autonomous travel vehicle and the work machine longer includes to separate the first travel path and the second travel path.

20. The control method for an autonomous travel vehicle according to claim 18, wherein
the autonomous travel vehicle travels along a travel path, and
to make the distance between the autonomous travel vehicle and the work machine longer includes to generate the travel path so as to be separated from the work machine.
